(19) United States
(12) Patent Application Publication
(10) Pub. No.: US 2025/0326482 A1
(43) Pub. Date: Oct. 23, 2025

(54) BLADE COMPRISING A STRUCTURE MADE OF COMPOSITE MATERIAL, AND ASSOCIATED MANUFACTURING METHOD

(71) Applicant: SAFRAN AIRCRAFT ENGINES, PARIS (FR)

(72) Inventors: Vincent JOUDON, MOISSY-CRAMAYEL (FR); Vivien Mickaël COURTIER, MOISSY-CRAMAYEL (FR); Gaël Robert GRAIL, MOISSY-CRAMAYEL (FR); Miguel RUIZ DE SOTTO, MOISSY-CRAMAYEL (FR); Laurent JABLONSKI, MOISSY-CRAMAYEL (FR)

(73) Assignee: SAFRAN AIRCRAFT ENGINES, PARIS (FR)

(21) Appl. No.: 18/870,630

(22) PCT Filed: May 26, 2023
(86) PCT No.: PCT/FR2023/050740

§ 371 Date: Nov. 29, 2024

(30) Foreign Application Priority Data
May 31, 2022 (FR) FR2205243

(51) Int. Cl. B64C 11/26; B64C 11/06; F04D 29/38

(52) U.S. Cl. CPC B64C 11/26; B64C 11/06; F04D 29/388

(57) ABSTRACT

The invention relates to a blade comprising, a blade body having an aerodynamic profile comprising a first fibrous reinforcement obtained by three-dimensional weaving and comprising a first matrix in which the first fibrous reinforcement is embedded, the blade body part comprising a cavity formed by a disconnection of the first fibrous reinforcement, a blade root intended to be connected to a mechanism for the variable adjustment of the blade, and a spar comprising a core made of composite material and two metal casings attached to the core on either side of the core. The core comprises a first part that extends inside the cavity of the blade body and a second part that forms the blade root. The two metal casings which are attached to the core made of composite material extend over the second part and continue to extend over the first part inside the cavity of the blade body.

### TECHNICAL FIELD

The invention relates to a blade comprising a structure of composite material and the associated manufacturing method.

### PRIOR ART

The advantage of unducted-fan engines is that the diameter of the fan is not limited by the presence of a duct so that it is possible to design an engine having a high bypass ratio, and consequently a reduced fuel consumption.

Thus, in this type of engine, the blades of the fan can have a large span.

In addition, these engines generally comprise a mechanism allowing modifying the pitch angle of the blades in order to adapt the thrust generated by the fan depending on the different phases of flight.

However, the design of such blades necessitates taking contradictory constraints into account.

On the one hand, the dimensioning of these blades must allow optimal aerodynamic performance (maximizing efficiency and supplying thrust while minimizing losses). The improvement of the aerodynamic performance of the fan tends toward an increase in the bypass ratio (BPR), which is manifested in an increase in the outer diameter, and therefore of the span of these blades.

On the other hand, it is also necessary to guarantee resistance to the mechanical stresses which can be exerted on these blades, while limiting their acoustic signature.

Moreover, in the architectures with an unducted fan, starting the engine is generally accomplished with a very open pitch. In fact, a very open pitch allows consuming power through the torque, which ensures machine safety while guaranteeing low fan speeds.

But with a very open pitch, the blades undergo a turbulent aerodynamic flow, completely separated, which generates a wide-band vibrational excitation. In particular on blades with a large chord and large span, the bending force is intense even though the engine speed is not maximal.

In normal operation, during ground phases and in flight, the pitch is modified (the pitch angle is more closed). The aerodynamic flow is therefore perfectly healthy (attached to the aerodynamic profile). Wide-band stresses disappear, the rotation speed is higher, and the bending force is controlled.

These blades can be made of metallic material. Though blades of metallic material have good mechanical resistance, they have however the disadvantage of having a relatively large mass.

In order to reduce this mass, it is desirable to be able to manufacture these blades of composite material. However, the intense aerodynamic forces to which these blades are subjected would risk damaging the blade and/or the hub in the interface zone between these blades and the hub of the rotor of the fan, at the blade root.

Document WO2022/18353 describes a blade comprising an airfoil with an aerodynamic profile and a spar. The spar comprises a core of composite material, the core of composite material having a first part inside the airfoil with an aerodynamic profile and a second part extending from the first part outside the airfoil with an aerodynamic profile, so as to form a blade root. The spar also comprises two metallic shells which cover a hump in the blade root of composite material.

The metallic shells constitute a structural reinforcement of the blade root. However, in such a configuration, there remains a risk of detachment of the metallic shells and, thereafter, an abrupt change in the mechanical behavior of the system.

### BRIEF DESCRIPTION OF THE INVENTION

One object of the invention is to design a blade comprising an airfoil with an aerodynamic profile and a blade root of composite material reinforced by metallic shells resisting the detachment of the shells.

To this end, the invention proposes a blade comprising:
an airfoil with an aerodynamic profile comprising a first fibrous reinforcement obtained by three-dimensional weaving and a first matrix in which the first fibrous reinforcement is embedded, the airfoil part with an aerodynamic profile comprising a cavity formed by a debinding of the first fibrous reinforcement,
a blade root intended to be connected to a variable pitch mechanism of the blade, and
a spar comprising a core of composite material and two metallic shells attached to the core of composite material, on either side of the core of composite material, the core of composite material comprising a first part extending inside the cavity of the airfoil, and a second part forming the blade root,
   the two metallic shells attached to the core of composite material extending over the second part and continuing over the first part inside the cavity of the airfoil with an aerodynamic profile.

The continuation avoids the transmission of aerodynamic forces from the airfoil with an aerodynamic profile to the metallic shells by means of the composite material, which would subject the boundary between the metallic shells and the composite material to large shear forces which could cause the detachment of the shells. The metallic shells that continue inside the cavity directly ensure the transmission of aerodynamic forces to the attachment zone by means of bending forces.

According to other optional features of the invention, taken alone or in combination when that is technically possible:
the blade root has an axisymmetrical shape around a pitch axis of the blade, and the first part has a first thickness, measured in a plane passing through the pitch axis and an intersection point between a leading edge line of the airfoil and a stream limit chord line located at a limit between the airfoil and the root, which increases from the stream limit chord to the interior of the airfoil over at least a portion of the first part;
the first part has a second thickness, measured in a second plane, perpendicular to the first plane, which decreases from the stream limit chord to the interior of the airfoil over the portion of the first part;
the first fibrous reinforcement comprises weft strands extending from the leading edge to the trailing edge and delimiting the debinding, the debinding being delimited upstream by first interweavings between the weft strands and downstream by second interweavings between the wefts;
a distance measured between a first interweaving and a second interweaving of the weft strands delimiting the debinding, in a plane perpendicular to the pitch axis, increases from the blade root to the interior of the airfoil;
the blade comprises a workpiece of rigid cellular material, the rigid cellular material preferably being a polyurethane foam, the workpiece being attached to the first part of the spar and positioned in the cavity of the airfoil with an aerodynamic profile;
the two metallic shells attached to the core of composite material are not joined together, hence disjoint without direct contact;
the first part of the core of composite material comprises facets and each of the two metallic shells has facets able to be positioned in contact with the facets of the first part, so as to define a relative positioning of each of the shells relative to the core;
the airfoil with an aerodynamic profile has a first end connected to the blade root and a second end, opposite to the first end, and in which the debinding of the first fibrous reinforcement forming the cavity in which the first part of the spar is inserted extends from a first opening leading into the first end to a second opening leading into a leading edge of the airfoil;
the first fibrous reinforcement is obtained by three-dimensional weaving of strands of carbon fibers and the first matrix comprises an epoxy resin;
the core of composite material of the spar comprises a second fibrous reinforcement obtained by three-dimensional weaving and a second matrix in which the second fibrous reinforcement is embedded;
the second fibrous reinforcement comprises a plurality of layers of fibrous reinforcement stacked on one another, and arranged in such a manner that the layers of fibrous reinforcement have stiffnesses which decrease when the second fibrous reinforcement is followed from the interior of the second fibrous reinforcement to the outside of the second fibrous reinforcement;
the blade root has an axisymmetrical shape around a pitch axis of the blade, and the second part has a radial dimension, measured along a radial axis perpendicular to the pitch axis, which increases continuously then decreases continuously when the second part is followed along the pitch axis while moving away from the first part, so as to form a hump.
   The invention also relates to a blade assembly comprising:
a blade as previously described, and
an attachment device comprising a first attachment part able to be supported on a portion of the blade root in which the radial dimension increases continuously, a second attachment part able to be supported on a portion of the blade root in which the radial dimension decreases continuously, and a third attachment part having contours suitable for cooperating with contours of the first attachment part to block the first attachment part in translation along the pitch axis relative to the third attachment part, the second attachment part having an aperture and the third attachment part having an aperture intended to be facing the aperture of the second attachment part so as to allow the insertion of a blocking member into the facing apertures in order to hold in compression the hump between the first attachment part and the second attachment part.

Another object of the invention is to design a manufacturing method for a blade comprising an airfoil with an aerodynamic profile and a blade root of composite material reinforced by metallic shells resistant to detachment of the shells.

For this reason, the invention proposes a manufacturing method for a blade as described previously comprising the successive steps of:
producing the spar core of composite material comprising a first part and a second part,
attaching the two metallic shells to the core of the spar, so that each of the two metallic shells extends over the second part and continues over the first part,
producing a fibrous blank by three-dimensional weaving of fiber strands, the blank having a debinding forming a cavity,
forming the fibrous blank to obtain a preform with an aerodynamic profile, the forming comprising the insertion of the first part of the spar inside the cavity,
injecting a resin into a mold containing the first fibrous blank and the spar to obtain a blade comprising an airfoil with an aerodynamic profile having a first fibrous reinforcement densified by a matrix, the first part of the spar extending inside the cavity of the airfoil, and the second part of the spar forming the blade root.

According to other optional features of the invention, taken alone or in combination when that is technically possible:
the step of forming the fibrous blank is preceded by a step of assembling the spar with a workpiece of rigid cellular material, the rigid cellular material preferably being a polyurethane foam, so that the first part of the spar is inserted with the workpiece inside the cavity formed by the debinding of the fibrous blank;
the debinding of the fibrous blank is continued to a second opening in the leading edge line of the airfoil, and the spar is inserted inside the cavity formed by the debinding of the fibrous blank through the opening;
the step of producing the core of the spar comprises machining a hump having facets on one end of the first part of the core and the step of attaching the two metallic shells to the core comprises positioning each of the two shells against the facets, so as to define a relative positioning of each of the shells relative to the core.

### BRIEF DESCRIPTION OF THE FIGURES

Other features and advantages of the invention will be revealed by the detailed description that follows, with reference to the appended drawings, in which:

FIG. 1 shows schematically an example of an engine including an unducted fan.

FIG. 2 shows schematically a fan blade and an attachment device allowing modifying the pitch angle of the fan blades around the pitch axis.

FIG. 3A shows schematically a spar of the blade along a section in a first plane comprising the pitch axis and the intersection point between the leading edge line and the stream limit chord between an airfoil with an aerodynamic profile of the blade and a root of the blade.

FIG. 3B shows schematically the spar of the blade in a section in a second plane containing the pitch axis and perpendicular to the second plane.

FIG. 4 shows schematically the core of the spar of composite material in a transverse section A-A of the spar, in a plane perpendicular to the pitch axis.

FIG. 5 shows schematically facets allowing the relative positioning of the metallic shells and of the core of composite material of the spar in a transverse section C-C of the spar.

FIG. 6 shows a manufacturing method of a blade including a spar.

FIG. 7 shows schematically a step of inserting the spar into the airfoil of the blade.

### DETAILED DESCRIPTION OF EMBODIMENTS

### Description of the Blade

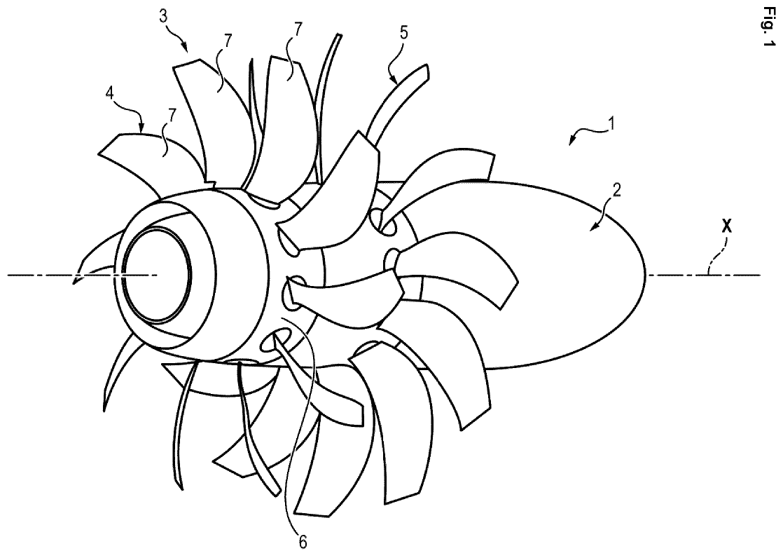

In FIG. 1, the engine 1 shown is an engine of the “open rotor” type, in a configuration currently qualified as “pusher” (i.e. the fan is placed at the rear of the power generator with an air inlet located on the side, on the right in FIG. 1).

The engine comprises a nacelle 2 intended to be attached to a fuselage of an aircraft, and an unducted fan 3. The fan 3 comprises two counter-rotating fan rotors 4 and 5. In other words, when the engine 1 is operating, the rotors 4 and 5 are driven in rotation relative to the nacelle 2 around the same axis of rotation X (which coincides with a main axis of the engine), in opposite directions.

In the example illustrated in FIG. 1, the engine 1 is an engine of the “open rotor” type in a “pusher” configuration, with counter-rotating fan rotors. However, the invention is not limited to this configuration. The invention also applies to engines of the “open rotor” type in “puller” configuration (i.e. the fan is placed upstream of the power generator with an air inlet located forward, between or just behind the two fan rotors).

In addition, the invention also applies to engines having different architectures, such as an architecture comprising a fan rotor comprising movable blades and a fan stator comprising fixed blades, or a single fan rotor.

The invention is applicable to architectures of the turboprop type (comprising a single fan rotor).

In FIG. 1, each fan rotor 4, 5 comprises a hub 6 mounted in rotation relative to the nacelle 2, and a plurality of blades 7 attached to the hub 6. The blades extend substantially radially relative to the axis of rotation X of the hub.

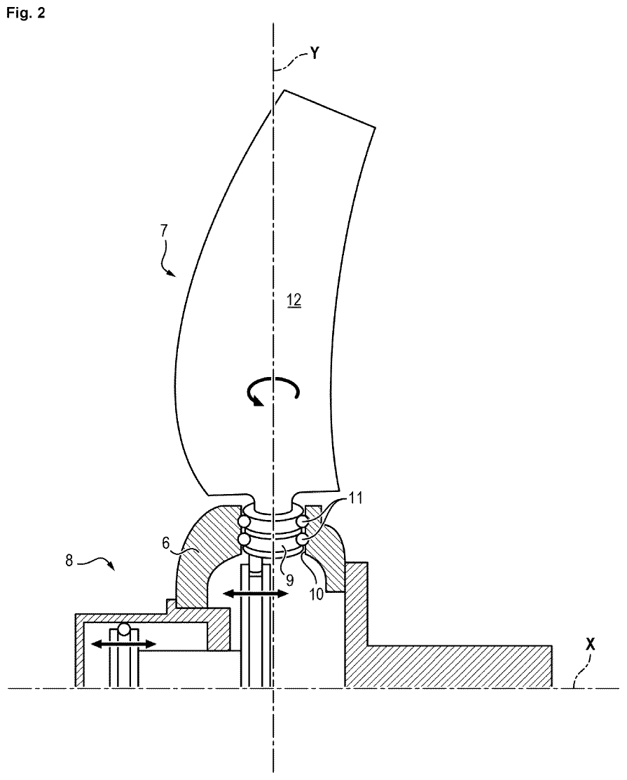

As illustrated in FIG. 2, the fan 3 also comprises an actuation mechanism 8 allowing collective modification of the pitch angle of the blades of the rotors, in order to adapt the performance of the engine to different phases of flight. To this end, each blade 7 comprises a blade root 9 and an airfoil 12 with an aerodynamic profile. The blade root 9 is mounted in rotation relative to a hub 6 around a pitch axis Y. More precisely, the blade root 9 is mounted in rotation inside an attachment device 10 provided in the hub 6, by means of balls 11 or other rolling elements.

The airfoil 12 with an aerodynamic profile has a first end connected to the blade root and a second end, opposite to the first end. The airfoil 12 part with an aerodynamic profile is intended to extend in an air stream of the engine, when the engine is operating, in order to generate lift. On the other hand, the blade root 9 is intended to extend outside the air stream.

The airfoil 12 with an aerodynamic profile has a structure of composite material comprising a first fibrous reinforcement obtained by three-dimensional weaving of strands and a first matrix in which the first fibrous reinforcement is embedded. The first fibrous reinforcement is obtained for example by three-dimensional weaving of carbon fiber strands and the first matrix can comprise an epoxy resin.

The first fibrous reinforcement comprises a debinding which delimits a cavity inside the airfoil 12 with an aerodynamic profile. The cavity leads into a first opening 25 at the first end of the airfoil 12 with an aerodynamic profile. The cavity preferably extends from this first opening 25 to a second opening 24 leading into a leading edge of the airfoil.

Referring to FIG. 4, the first fibrous reinforcement can comprise a first set of weft strands 26 which extend from the leading edge to the trailing edge of the airfoil with an aerodynamic profile and which delimit the debinding upstream with a first interweaving 26a between said wefts of the first set of weft strands and downstream by a second interweaving 26b.

The first fibrous reinforcement can also comprise a second set of weft strands 27 which extend in the skin of the airfoil with an aerodynamic profile (i.e. these are the strands nearest the outer surface of the airfoil 12 with an aerodynamic profile), from the leading edge to the trailing edge, without or with few local interweavings in the low-thickness zones of the preform, so as to give the shape of the airfoil. The second set of weft strands 27 constitutes reinforcement against the deformation of the airfoil, particularly at the time of injecting the resin intended to form the first matrix. Finally, a third set of weft strands 28 can also extend from the leading edge to the trailing edge. The weft outputs of this third set 28 provide rapid variations of thickness of the airfoil 12.

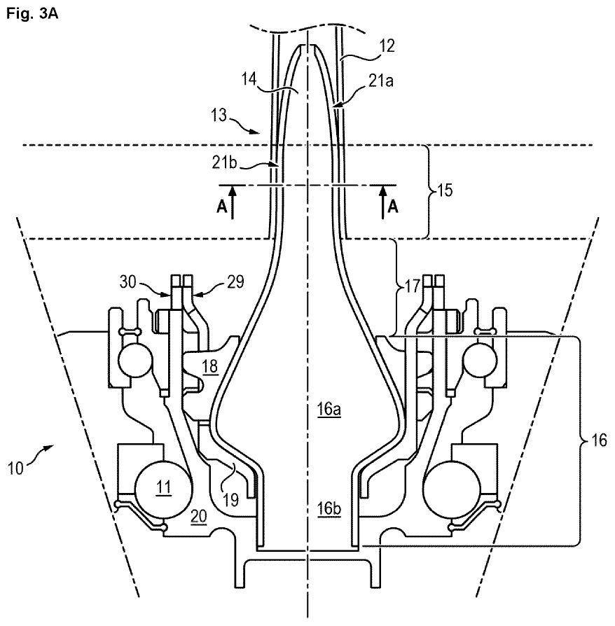

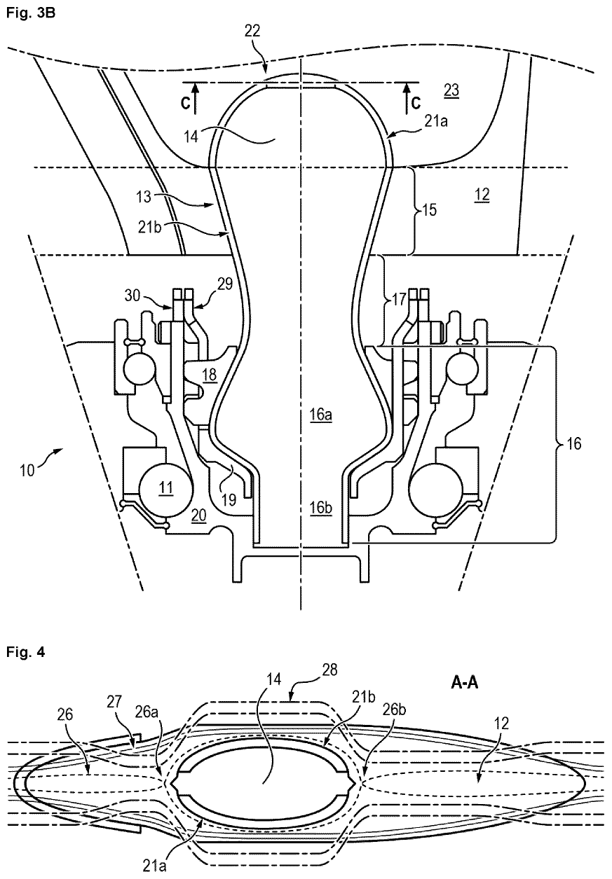

The fan blade 7 also comprises a spar 13 shown in FIGS. 3A and 3B. The spar itself comprises a core 14 of composite material.

The core 14 of composite material comprises a first part extending inside the cavity of the airfoil, and a second part forming the blade root 9.

The first part of the core allows the transmission of the forces undergone by the airfoil 12 with an aerodynamic profile to the blade root 9. The shape of the first part of the core is selected so as to ensure the retention of the airfoil 12 on the root 9.

A first plane is defined which passes through the pitch axis Y and an intersection point between a leading edge line of the airfoil and a stream limit chord line located at a limit between the airfoil 12 and the root 9, the spar 13 being shown in the first plane in FIG. 3A. As can be seen in FIG. 3A, the first part has a first thickness which, measured in the first plane, preferably increases from the stream limit chord to the interior of the airfoil over at least a portion 15 of the first part.

Reciprocally, a distance measured between a first interweaving 26a and a second interweaving 26b of two weft strands of the first fibrous reinforcement, the first and second interweavings 26a, 26b delimiting the debinding, increases from the first opening of the cavity at the stream limit chord to the interior of the airfoil in the same first plane, so that the weft strands 26 most closely surround the first part of the core of the spar 13.

The first part can be attached in the cavity directly by the resin constituting the first matrix, or by means of a film of adhesive.

When the fan is in rotation, the blade 7 undergoes centrifugal forces oriented in a radial direction relative to the axis of rotation of the fan, which tend to separate the airfoil 12 with an aerodynamic profile from the spar 13. The anchoring of the airfoil 12 on the spar 13 is provided both by the adhesive or the resin and by the shrinking of the joint cross section of the first part and of the cavity from the inside of the airfoil to the stream limit chord. Thus, even in case of breakage of the interface between the spar 13 and the resin or the adhesive film, the cross section shrinkage ensures the retention of the airfoil 12 with an aerodynamic profile on the spar 13.

In addition, as can be seen in FIG. 3B, the first part of the core has a second thickness which, measured in a second plane comprising the pitch axis Y and perpendicular to the first plane, decreases from the stream limit chord to the interior of the airfoil in the portion 15 of the first part.

As can be seen in FIGS. 3A or 3B, the second part of the core comprises two portions. The first portion of the second part of the core or attachment portion 16 is attached to the interior of the attachment device 10 and provides the function of attaching the blade to the hub. The second portion, called the stilt 17, forms the link between the attachment portion 16 located inside the attachment device 10 and the first part of the core located inside the airfoil.

The stilt 17 provides the transmission of aerodynamic forces from the first part of the core to the attachment zone. A first dimension of the stilt 17 measured in the first plane increases when moving from the attachment zone to the airfoil. On the contrary, a second dimension of the stilt 17 measured in the second plane decreases when moving in the same direction to reach, at the limit of the stream, the dimension imposed by the airfoil 12 with an aerodynamic profile. The increase in cross section of the stilt 17 from the attachment zone to the airfoil 12 with an aerodynamic profile in the first plane allows the stilt 17 to provide better transmission of the forces.

The first portion of the second part 16 is intended to be inserted into the variable-pitch attachment device 10 of the blade 7. A radial dimension of the first portion 16, measured along a radial axis perpendicular to the pitch axis Y, increases continuously when following the first portion of the second part along the pitch axis Y while moving away from the first part defining a first frusto-conical surface called the “upper bearing surface.” Then, the radial dimension decreases continuously, defining a second frusto-conical surface called the “lower bearing surface.” An evolution of this type of the radial dimension corresponds to a hump 16a. In other words, the first portion has the shape of a bulb.

When the first portion 16 is inserted into the attachment device 10 and the blade 7 is in rotation, the upper bearing surface ensures the retention of the blade 7 under the influence of the centrifugal force, thus ensuring the taking up of the tension forces that are substantially radial relative to the axis X. The upper bearing surface also ensures the taking up of the tangential bending forces exerted circumferentially relative to the axis X on the airfoil 12 with an aerodynamic profile, the bending forces resulting from the swirling of the air by the airfoil.

The lower bearing surface allows applying a pre-load during the assembly of the blade root 9 into the attachment device 10, i.e. the blade root is pressed between the upper bearing surface and the lower bearing surface.

The first portion of the second part 16 can also comprise a pitch member 16b which extends from the lower bearing surface. The pitch member 16b has no axial symmetry around the pitch axis Y so that the pitch member 16b allows controlling the pitch of the blade 7, particularly in case of an excess torque occurring for example during a bird ingestion. The pitch member 16b then intervenes as an integral safety member.

The variable-pitch attachment device 10 comprises a first segmented attachment part 18 able to be supported on the portion of the blade root 9 in which the radial dimension increases continuously.

The attachment device 10 also comprises a second attachment part 19, called the inner rolling ring, which is able to be supported on the portion of the blade root 9 in which the radial dimension decreases continuously.

Finally, the attachment device 10 comprises a third attachment part 20. The third attachment part 20 has contours able to cooperate with contours of the first attachment part 18 to block the first attachment part 18 in translation along the pitch axis Y relative to the third attachment part 20.

The second attachment part 19 has an aperture 29. The third attachment part 20 has an aperture 30 intended to be placed facing the aperture 29 of the second attachment part 19, so as to allow the insertion of a blocking member, for example a screw, into the facing apertures 29, 30 in order to hold the hump 16a in compression the between the first attachment part 18 and the second attachment part 19.

The core 14 of composite material of the spar 13 comprises a second fibrous reinforcement obtained by three-dimensional weaving and a second matrix in which the second fibrous reinforcement is embedded.

The second fibrous reinforcement can be woven in three dimensions and have a debinding delimiting a central cavity in which a workpiece is inserted, for example a polyurethane foam. The workpiece allows obtaining the desired shape and thickness for the spar.

Alternatively, the second fibrous reinforcement can comprise a plurality of layers of fibrous reinforcement stacked on one another. According to this embodiment, each layer of fibrous reinforcement extends over the entire length of the core, the thickness of each layer varying over said length. The thickness variations of each layer adding, it is thus possible to obtain the desired shape of the core with in particular the expected humps.

Still alternatively, the second fibrous reinforcement can comprise a layer of fibrous reinforcement the width of which is substantially equal to the length of the spar, the layer of fibrous reinforcement being wound over itself. The thickness variations of the layer of fibrous reinforcement over its width allow obtaining the desired shape for the spar.

The stiffness, or Young's modulus, of the second fibrous reinforcement can vary in the different zones of the second fibrous reinforcement. Thus, the stiffness of the second fibrous reinforcement can advantageously decrease when the second fibrous reinforcement is followed from the interior of the second fibrous reinforcement to the outside of the second fibrous reinforcement.

By way of an example, the stiffness variation between the core and the skin of the second fibrous reinforcement can be obtained in the case of a layer of fibrous reinforcement wound over itself if the layer of fibrous reinforcement does not have the same stiffness over its entire length.

Also by way of an example, the stiffness variation can be obtained by superimposing a plurality of layers of fibrous reinforcement, said layers then being arranged so that they have stiffnesses that decrease when the second fibrous reinforcement is followed from the interior of the second fibrous reinforcement to the outside of the second fibrous reinforcement. This stiffness then varies between the different layers of fibrous reinforcement and within each layer.

The stiffness variation can also be obtained when the second fibrous reinforcement comprises a layer of fibrous reinforcement, the stiffness of the layer varying over the thickness and/or the width of the layer.

In addition to the core 14 of composite material, the spar comprises two metallic shells 21a, 21b attached to the core 14, for example by mechanical assembly or preferably by gluing. The two metallic shells 21a, B21b are positioned on either side of the core 14, like nutshells. The two metallic shells 21a, 21b are impressions of the core 14 of composite material, so that the shape of the spar 13 which comprises the metallic shells 21a, 21b and the core 14 of composite material is similar to the shape of the core 14 described previously.

The two metallic shells 21a, 21b extend over the second part of the core 14 and continue over the first part inside the cavity of the airfoil 12 with an aerodynamic profile. Thus, according to one embodiment, the two metallic shells 21a, 21b cover the bulb-shaped 16a attachment portion 16 continued by the pitch member 16b, the stilt 17 and at least one portion of the first part of the core inside the cavity. According to one particular embodiment, the two metallic shells 21a, 21b continue to the end of the first part of the core 14.

At the portion on which the metallic shells 21a, 21b continue inside the cavity, the spar 13 is therefore attached to the airfoil 12 with an aerodynamic profile by means of the metallic shells 21a, 21b, either directly by the resin, or by a film of adhesive as previously mentioned.

The two metallic shells 21a, 21b constitute a structural reinforcement of the core 14 of composite material. Their continuation inside the cavity of the airfoil 12 with an aerodynamic profile ensures a transmission of the aerodynamic forces from the airfoil 12 which is more direct than in a configuration in which the shells would extend over the second part of the core but would not continue inside the cavity. In fact, the absence of continuation of the metallic shells over the first part of the core would force transmission of the forces from the airfoil to the shells by means of the composite material, subjecting the stilt 17 to shear forces. The metallic shells 21a, 21b which extend inside the cavity directly ensure the transmission of the aerodynamic forces to the attachment zone by means of bending forces.

In addition, the continuation of the shells 21a, 21b inside the airfoil 12 with an aerodynamic profile ensures continuity of the stiffnesses and allows avoiding discontinuities of macroscopic mechanical characteristics between the attachment zone 16, the stilt 17 and the airfoil 12 with an aerodynamic profile at least in proximity to the stream air limit. The shells 21a and 21b participate in a transmission of the aerodynamic bending forces and of centrifugal tension forces which are exerted on the airfoil 12 with an aerodynamic profile toward the attachment zone 16. This avoids having these forces transit only through the core 14 of composite material in the thinned zone where the stilt 17 or the core 14 of composite material have a reduced thickness in the second plane (FIG. 3B) and where consequently these forces are concentrated.

Finally, in a configuration in which the metallic shells would extend over the first part of the core, but would not continue inside the cavity of the airfoil, the end of the metallic shells considered when moving toward the airfoil would constitute a free edge likely to concentrate the stresses. The concentration of the stresses on the edge could cause the detachment of the shells. The continuation of the metallic shells 21a, 21b inside the cavity therefore allows avoiding the detachment of the shells 21a, 21b and the abrupt change in mechanical behavior that would result from it.

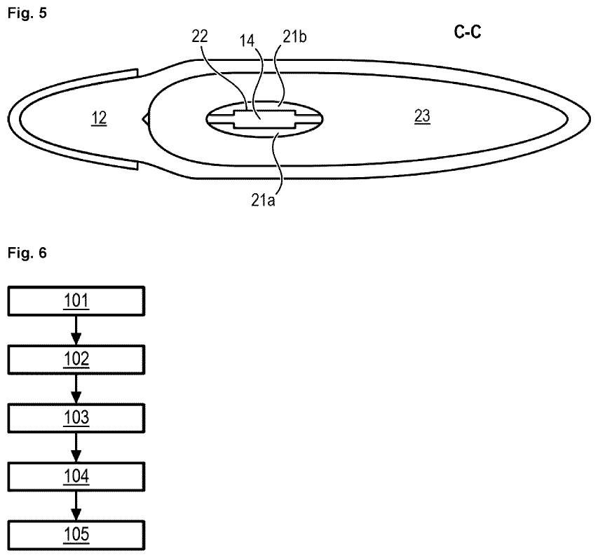

In order to define the relative positioning of each of the shells 21a, 21b relative to the core 14 of composite material, each of the two metallic shells 21a, 21b can have facets 22. According to this embodiment, shown in more detail in FIG. 5, the first part of the core also comprises facets, the facets of each of the two metallic shells 21a, 21b are positioned in contact with the facets 22 of the first part of the core.

Preferably, the two metallic shells 21a, 21b attached to the core 14 of composite material are not joined together, i.e. disjoint from one another without direct contact, so as to allow good attachment of the metallic shells 21a, 21b to the core 14 of composite material. In particular, during attachment by gluing, the goal is not to leave space between each of the two metallic shells 21a, 21b and the core 14 of composite material. If the metallic shells 21a, 21b are not correctly placed against the core 14 of composite material, there is a risk of discontinuity in mechanical behavior, for example in the case of a shock during contact with a bird, which could cause the appearance of internal weakening zones in the blade.

According to one embodiment, when the spar 13 is positioned in the cavity of the airfoil 12 with an aerodynamic profile, each of the two metallic shells 21a, 21b extends around the core 14 from the leading edge to the trailing edge, so that the first of the two metallic shells 21a is positioned overall toward the pressure side of the airfoil and the second of the two metallic shells 21b is positioned overall toward the suction side of the airfoil.

According to an alternative embodiment, each of the two metallic shells 21a, 21b extends around the core 14 from the pressure side to the suction side, so that the first of the two metallic shells 21a is positioned overall at the leading edge of the airfoil and the second of the two metallic shells 21b is positioned overall at the trailing edge of the airfoil.

A positioning of the metallic shells 21a, 21b on the pressure side and the suction side has the advantage of being more easily machinable, the shape of each of the two metallic shells 21a, 21b being relatively flat in this configuration, while a positioning of the metallic shells 21a, 21b at the leading edge and trailing edge offers a better response of the shells 21a, 21b to bending forces.

Aside from the airfoil 12 with an aerodynamic profile and the spar 13, the blade can comprise a workpiece 23 of rigid cellular material. The workpiece 23 is then attached to the spar comprising the metallic shells and positioned in the cavity of the airfoil formed by the debinding. According to this embodiment, the dimensions of the cavity therefore allow the introduction of the foam and of the spar 13 into the cavity.

The rigid cellular material is preferably a polyurethane foam. Alternatively, the rigid cellular material can be a previously weatherproofed aluminum honeycomb material.

The workpiece 23 allows giving the desired thickness and shape to the airfoil 12 with an aerodynamic profile of the blade 7, while using a material that is lighter than other elements of the blade.

### Method for Manufacturing the Blade

The invention also relates to a method for manufacturing a blade 7 as previously described, comprising an airfoil 12 with an aerodynamic profile and a spar 13, the spar 13 itself comprising a core 14 of composite material and two metallic shells 21a, 21b. With reference to FIG. 6, the method for manufacturing the blade 7 comprises the successive steps of:
producing 101 the spar core 14 of composite material comprising a first part and a second part,
attaching 102 the two metallic shells 21a, 21b to the core 14 of the spar, so that each of the two metallic shells 21a, 21b extends over the second part and continues over the first part,
producing 103 a fibrous blank by three-dimensional weaving of fiber strands, the blank having a debinding forming a cavity,
forming 104 the fibrous blank to obtain a preform with an aerodynamic profile, the forming comprising the insertion of the first part of the spar 13 inside the cavity,
injecting 105 a resin into a mold containing the first fibrous blank and the spar 13 to obtain a blade 7 comprising an airfoil 12 with an aerodynamic profile having a first fibrous reinforcement densified by a matrix, the first part of the spar 13 extending inside the cavity of the airfoil 12, and the second part of the spar 13 forming the blade root 9.

### Producing 101 the Core 14 of Composite Material of the Spar 13

The production 101 of the core 14 of composite material comprises the preparation of the second fibrous reinforcement, then the injection of the second matrix to embed the second fibrous reinforcement.

According to a preferred embodiment, the second fibrous reinforcement is prepared by three-dimensional weaving of weft strands and by producing, during weaving, a debinding around an insert of a workpiece, so that the workpiece finds itself in a cavity of the second fibrous reinforcement. This embodiment has the advantage of allowing good control of the thickness of the spar core. Weaving allows arranging good fiber interweaving to obtain the mechanical characteristics desired of the second fibrous reinforcement in the resin.

The workpiece can be a previously machined polyurethane foam. Alternatively to the foam, nomex, paper or aluminum honeycomb materials can be used. The wefts used can be carbon fibers. Alternatively, glass fibers or aramid fibers can be used.

Optionally, the second fibrous reinforcement is woven so that the stiffness of the second fibrous reinforcement varies over the width and/or the thickness of said fibrous reinforcement. Advantageously, the second fibrous reinforcement is woven so that the stiffness decreases when the second fibrous reinforcement is followed from the interior of the second fibrous reinforcement to the outside of the second fibrous reinforcement.

Then the second fibrous reinforcement is positioned in a rigid and solid mold. The mold gives the second fibrous reinforcement the shape in which the second fibrous reinforcement will be fixed. A liquid resin is then injected at lower pressure into the mold, according to a method called “resin transfer molding” known to a person skilled in the art by the acronym RTM.

This method allows obtaining composite parts having a good surface condition over their entire surface.

An epoxy resin sufficiently fluid for good impregnation is preferably injected. The epoxy resin contributes good mechanical characteristics, in particular good matter-cohesion characteristics. Alternatively any other thermosetting resin can be used, or even a thermoplastic resin which are variant embodiments known to a person skilled in the art.

Finally it is possible to machine the ends of the core 14 fixed by the resin to define facets 22 which will be used as dimensional references for the relative positioning of the two metallic shells 21a, 21b.

Alternatively, the second fibrous reinforcement can be produced by stacking several layers of fibrous reinforcement, each layer being prepared by three-dimensional weaving of the weft strands. Then the stack of layers is impregnated with resin. The excess of fibers in the length direction is cut away. Finally, the assembly can be slightly machined to give the final shape to the part. Thus, a single injection of resin is preferably accomplished in the second fibrous reinforcement comprising the stack of different layers of fibrous reinforcement because it allows obtaining a more homogeneous assembly than was allowed by the superposition of several layers having previously been impregnated with resin in distinct injection steps.

Still alternatively, the second fibrous reinforcement can be prepared by winding one or more layers of fibrous reinforcement. The layer of fibrous reinforcement wound over itself is then positioned in a mold and injected with resin.

Optionally, it is possible to weave the layers of fibrous reinforcement so as to reduce the thickness of the second fibrous reinforcement when the second fibrous reinforcement is followed from the interior of the second fibrous reinforcement to the outside of the second fibrous reinforcement.

Alternatively and in a non-limiting fashion, it is possible to use bidirectional, unidirectional or braided composite weaving.

### Attachment 102 of the Two Metallic Shells 21a, 21b to the Core 14 of the Spar

In a non-limiting manner, the two metallic shells 21a, 21b are manufactured of: titanium, titanium alloy (ta6v for example), of steel or of aluminum.

The two metallic shells 21a, 21b are preferably produced by a forging method completed by mechanical and/or chemical machining.

During the forging method, the selected material is deformed by shock or by passage between two tools, cold or hot, so as to adopt the desired shape. Compared to molding, the forging method has the advantage of resulting in shells 21a, 21b having good metallic characteristics via an organization of the matter and a precise formation allowing limiting subsequent machining.

Chemical or mechanical machining, by removing matter, allows giving each of the two metallic shells the desired shape and dimensions. For example, machining can comprise the formation of facets complementary to the facets 22 machined on the core 14 of composite material to allow the positioning of the metallic shells 21a, 21b on the core 14.

The surface of the core 14 of composite material is treated prior to the attachment of the two metallic shells 21a, 21b. The purpose of the treatment is to obtain good roughness and improve the surface condition of the composite material by eliminating dust and grease. The treatment of the surface of the core 14 of composite material can comprise sandblasting.

The two metallic shells 21a, 21b are then applied around the composite part of the spar 13, possibly by mechanical assembly, for example by screwing, preferably by gluing. The polymerization of the adhesive film can be accomplished in an autoclave, under vacuum. The prior treatment of the surface of the core 14 of composite material ensures good bonding.

In the case where the facets have been machined on the core 14 of composite material and on the two metallic shells 21a, 21b, each of the two metallic shells 21a, 21b is positioned against the facets 22. The facets 22 allow defining a relative positioning of the shells 21a, 21b relative to the core 14.

Finally, the spar 13 thus assembled can be machined to perfect its final exterior geometry.

### Production 103 of the First Fibrous Blank

The first fibrous blank is produced by three-dimensional weaving of weft strands. The first fibrous blank is woven so as to have a debinding forming a cavity which extends from a first opening 25 to one end of the first fibrous blank located at the blade root 9.

The debinding is preferably delimited upstream by first interweavings 26a between the weft strands and downstream by second interweavings 26b between the wefts. In addition, a distance measured between a first interweaving 26a and a second interweaving 26b of the weft strands 26 delimiting the debinding increases from the first opening to the interior of the cavity over at least a portion of the cavity.

The cavity can extend to a second opening 24 leading, for example, into a leading edge of the airfoil.

### Forming 104 of the First Fibrous Blank and Injection 105 of the Resin

Optionally, the spar 13 can be assembled with a workpiece 23 of rigid cellular material, the rigid cellular material preferably being a previously machined polyurethane foam.

The spar 13 is assembled with the workpiece 23 by gluing, preferably with a glue that can be polymerized at ambient temperature. If the core 14 of composite material comprises facets 22, said facets 22 can be used to correctly position the workpiece 23.

The surface of the spar 13 is then prepared by chemical means or by dry means, for example by laser or by very light sanding. The treatment of the surface of the spar 13 allows in particular obtaining a surface conditions having good granulometry for assembly by gluing.

It is then possible to deposit a film of adhesive on the first part of the spar 13, and possibly on the workpiece 23 if the workpiece 23 is present.

Then the first fibrous blank is formed to obtain a preform with an aerodynamic profile, the preform is held in tooling and the spar 13 is inserted into the cavity delimited by the debinding of the first fibrous blank so that, at the end of the insertion, the first part is found to be inserted inside the cavity and the second part forming the blade root 9 emerges through the first opening of the cavity. If the spar 13 has previously been assembled with a workpiece 23, it is the assembly comprising the first part and the workpiece 23 which is found to be inserted inside the cavity. The assembly comprising the preform, the spar 13 and optionally the workpiece 23 is placed prior to impregnation with the resin.

The assembly of the spar 13 with the workpiece 23 prior to their insertion into the cavity delimited by the debinding advantageously allows controlling the relative positioning of the spar 13 and of the piece 23 inside the cavity.

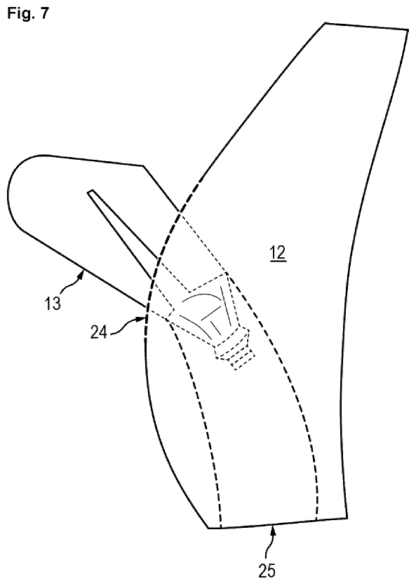

With reference to FIG. 7, if the debinding of the fibrous blank is prolonged so as to include a second opening 24 in the leading edge line of the airfoil, the spar is inserted inside the cavity formed by the debinding of the fibrous blank by the second opening 24, until the second part forming the blade root 9 emerges through the first opening 25 at the end of the airfoil root. The cross-section restriction at the first opening 25 ensures the retention of the first part of the spar 13 and of the possible workpiece 23.

A liquid resin is then injected into the mold containing the first fibrous blank and the spar 13 according to the RTM method to fix the airfoil 12 with an aerodynamic profile 12, the spar 13 and the possible workpiece 23 being in place at the time of the attachment.

A blade 7 is thus obtained comprising an airfoil 12 with an aerodynamic profile having a first fibrous reinforcement densified by a matrix, the first part of the spar 13 extending inside the cavity of the airfoil 12, and the second part of the spar 13 forming the blade root 9.

Finally, a metallic protection is added to the leading edge of the blade 7 and/or optionally a deicing system. The metal protection can comprise a titanium shield to avoid the deterioration of the composite material of the blade 7, on the one hand by the abrasion effect of sand or ice particles, on the other by the effect of shocks such as those resulting from contact with hail or a bird. Alternatively, it would be possible to use a shield comprising a layer of fabric.

1. A blade comprising:
an airfoil with an aerodynamic profile, the airfoil comprising a first fibrous reinforcement obtained by three-dimensional weaving and a first matrix in which the first fibrous reinforcement is embedded, a part of the airfoil with the aerodynamic profile comprising a cavity formed by a debinding of the first fibrous reinforcement,
a blade root intended to be linked to a variable pitch mechanism of the blade, and
a spar comprising a core of composite material and two metallic shells attached to the core of composite material, on either side of the core of composite material, the core of composite material comprising a first part extending inside the cavity of the airfoil with the aerodynamic profile, and a second part forming the blade root,
the two metallic shells attached to the core of composite material extending over the second part and continuing on the first part inside the cavity of the airfoil with the aerodynamic profile.

2. The blade according to claim 1, wherein the blade root has an axisymmetrical shape around a pitch axis of the blade, and the first part has a first thickness, measured in a plane passing through the pitch axis and an intersection point between a leading edge line of the airfoil with the aerodynamic profile and a stream limit chord line located between the airfoil with the aerodynamic profile and the blade root, which increases from the stream limit chord line to an interior of the airfoil with the aerodynamic profile over at least a portion of the first part.

3. The blade according to claim 2, wherein the first part has a second thickness, measured in a second plane, perpendicular to the first plane, which decreases from the stream limit chord line to the interior of the airfoil with the aerodynamic profile over the portion of the first part.

4. The blade according to claim 1, wherein the first fibrous reinforcement comprises weft strands extending from a leading edge of the airfoil with the aerodynamic profile to a trailing edge of the airfoil with the aerodynamic profile and delimiting the debinding, the debinding being delimited upstream by a first interweaving between the weft strands and downstream by a second interweaving between the weft strands.

5. The blade according to claim 4. wherein the blade root has an axisymmetrical shape around a pitch axis of the blade, and the first part has a first thickness, measured in a plane passing through the pitch axis and an intersection point between a leading edge line of the airfoil with the aerodynamic profile and a stream limit chord line located between the airfoil with the aerodynamic profile and the blade root, which increases from the stream limit chord line to an interior of the airfoil with the aerodynamic profile over at least a portion of the first part and wherein a distance measured between the first interweaving between the weft strands and the second interweaving between the weft strands, in a plane perpendicular to the pitch axis, increases from the blade root to the interior of the airfoil with the aerodynamic profile.

6. The blade according to claim 1, comprising a workpiece made of a rigid cellular material, the rigid cellular material being preferably a polyurethane foam, the workpiece being attached to the first part and positioned in the cavity of the airfoil with an aerodynamic profile.

7. The blade according to claim 1 wherein the two metallic shells attached to the core of composite material are not joined together.

8. The blade according to claim 1, wherein the first part comprises facets and each of the two metal shells has facets able to be positioned in contact with the facets of the first part, so as to define a relative positioning of each of the shells relative to the core of composite material.

9. The blade according to claim 1, wherein the airfoil with the aerodynamic profile has a first end connected to the blade root and a second end, opposite to the first end, and wherein the debinding of the first fibrous reinforcement forming the cavity in which the first part is inserted extends from a first opening leading into the first end of the airfoil with the aerodynamic profile to a second opening leading into the leading edge of the airfoil with the aerodynamic profile.

10. The blade according to claim 1, wherein the first fibrous reinforcement is obtained by three-dimensional weaving of strands of carbon fibers and the first matrix comprises an epoxy resin.

11. The blade according to claim 1, wherein the core of composite material of the spar comprises a second fibrous reinforcement obtained by three-dimensional weaving and a second matrix in which the second fibrous reinforcement is embedded.

12. The blade according to claim 11, wherein the second fibrous reinforcement comprises a plurality of layers of fibrous reinforcement stacked on one another, and arranged in such a manner that each layer of fibrous reinforcement of the plurality of layers of fibrous reinforcement has have stiffnesses which decrease when the second fibrous reinforcement is followed from an interior of the second fibrous reinforcement to an outside of the second fibrous reinforcement.

13. The blade according to claim 1, wherein the blade root has an axisymmetric shape around a pitch axis of the blade and the second part of the core of composite material has a radial dimension, measured, along a radial axis perpendicular to the pitch axis, which increases continuously then decreases continuously when the second part of the core of composite material is followed along the pitch axis while moving away from the first part, so as to form a hump.

14. A blade assembly comprising:
a blade according to claim 13, and
an attachment device comprising a first attachment part conducive to being supported on a portion of the blade root in which the radial dimension increases continuously, a second attachment part conducive to being supported on a portion of the blade root in which the radial dimension decreases continuously, and a third attachment part having contours able to cooperate with contours of the first attachment part to block the first attachment part in translation along the pitch axis relative to the third attachment part, the second attachment part having an aperture and the third attachment part having an aperture intended to be facing the aperture of the second attachment part, so as to allow an insertion of a blocking member into the facing apertures in order to hold in compression the hump between the first attachment part and the second attachment part.

15. A method for manufacturing a blade comprising successive steps of:
producing a core of composite material comprising a first part and a second part,
attaching two metallic shells to the core of composite material, so that each of the two metallic shells extends over the second part of the core of composite material and continue on the first part,
producing a fibrous blank by three-dimensional weaving of fiber strands, the fibrous blank having a debinding forming a cavity,
forming the fibrous blank to obtain a preform with an aerodynamic profile, wherein forming the fibrous blank comprises inserting the first part inside the cavity,
injecting a resin into a mold containing the first fibrous blank and the first part to obtain a blade comprising an airfoil with the aerodynamic profile comprising a fibrous reinforcement and a matrix in which the fibrous reinforcement is embedded, the first part extending inside the cavity of the airfoil with the aerodynamic profile, and the second part of the core of composite material) forming a blade root of the blade.

16. The method according to claim 15, wherein the step of forming the fibrous blank is preceded by a step of assembling a spar of the blade, comprising the core of composite material and the two metallic shells, with a workpiece of rigid cellular material, the rigid cellular material preferably being a polyurethane foam, so that the first part is inserted with the workpiece inside the cavity formed by the debinding of the fibrous blank.

17. The method according to claim 15, wherein the debinding of the fibrous blank is continued to a second opening in a leading edge of the airfoil with the aerodynamic profile, and the spar of the blade comprising the core of composite material and the two metallic shells, is inserted inside the cavity formed by the debinding of the fibrous blank through the second opening.

18. The method according to claim 15, wherein the step of producing the core of composite material of the spar comprises machining a hump having facets on one end of the first part and the step of attaching the two metallic shells to the core of composite material comprises positioning each of the two shells against the facets of the hump so as to define a relative positioning of each of the two metallic shells relative to the core of composite material.
